(19) United States
(12) Patent Application Publication
(10) Pub. No.: US 2009/0290793 A1
(43) Pub. Date: Nov. 26, 2009

(54) SIGNAL SEARCH IN THREE DIMENSIONAL BITMAPS

(75) Inventors: Kathryn A. Engholm, Portland, OR (US); Robert E. Tracy, Beaverton, OR (US)

Correspondence Address: MATTHEW D. RABDAU;TEKTRONIX, INC., 14150 S.W. KARL BRAUN DRIVE, P.O. BOX 500 (50-LAW), BEAVERTON, OR, 97077-0001, US

(73) Assignee: TEKTRONIX, INC., Beaverton, OR (US)

(21) Appl. No.: 12/471,126

(22) Filed: May 22, 2009

Related U.S. Application Data
(60) Provisional application No. 61/055,457, filed on May 22, 2008.

(51) Int. Cl. G06K 9/00; G06T 11/20

(52) U.S. Cl. 382/171; 345/440.1

(57) ABSTRACT

A method for automated searching of signal characteristics represented in a bitmap of an RF test and measurement device is provided. The bitmap is populated via sampling of a time-varying signal, where a first signal characteristic is reflected by an X-axis of the bitmap, a second signal characteristic is reflected by a Y-axis of the bitmap, and a third signal characteristic is reflected by a Z-axis of the bitmap. The method includes: selecting a region of the bitmap. The method further includes generating, for the region, a histogram of Z-values of the bitmap versus Y-values of the bitmap, searching the histogram for any portion in the histogram that meets a predetermined search criteria, and identifying a location of the bitmap corresponding to each portion of the histogram that meets the predetermined search criteria.

### CROSS-REFERENCE TO RELATED APPLICATIONS

This application claims priority from U.S. Provisional Patent Application Ser. No. 61/055,457 of Kathryn A. Engholm and Robert E. Tracy, entitled “Signal Search in a Display,” filed May 22, 2008, the disclosure of which is hereby incorporated by reference in its entirety and for all purposes.

### BACKGROUND

A variety of test and measurement devices exist for use in connection with RF signals. In many cases, these devices include components that provide real-time processing and other functionality that occurs as a time-varying signal is received, and other components that perform off-line functionality, such as a detailed signal analysis that occurs after a signal event has been captured and stored.

In some devices, the time-varying signal may be sampled and stored in a bitmap that may be displayed to a user. The bitmap may have X, Y, and Z axes that each reflect a different signal characteristic. Test and measurement operations are often performed by observing and manually interacting with the displayed bitmap or through automated searching of the bitmap. For example, in manual operation, a user can place measurement cursors on signals they have identified to read their X-axis value, Y-axis value, and/or Z-axis value.

In automated search operations, current search functions are often limited when applied to certain types of bitmap data. Although existing search functions are adequate in some cases, a variety of common signal situations exist where signal characteristics of interest cannot effectively be detected by these search functions.

For example, in a frequency-domain bitmap where multiple signals have been detected over time at the same frequency but at differing amplitudes, a user may easily identify each perceived signal and amplitude level via visual recognition. In contrast, it may be difficult for an automated search function to identify each signal. For example, a search function that sets a signal density threshold may not accurately identify all signals at a given frequency because each signal may have a different probability of occurrence, and there is often a wide range of background fill due to less frequently occurring signals that may mask the occurrence of a signal of interest. As another example, a search function that searches for peak amplitude may not accurately identify any signal other than the signal at the highest amplitude for a particular frequency.

### SUMMARY

A method for automated searching of signal characteristics represented in a bitmap of an RF test and measurement device is provided. The bitmap is populated via sampling of a time-varying signal, where a first signal characteristic is reflected by an X-axis of the bitmap, a second signal characteristic is reflected by a Y-axis of the bitmap, and a third signal characteristic is reflected by a Z-axis of the bitmap. The method includes: selecting a region of the bitmap. The method further includes generating, for the region, a histogram of Z-values of the bitmap versus Y-values of the bitmap, searching the histogram for any portion in the histogram that meets a predetermined search criteria, and identifying a location of the bitmap corresponding to each portion of the histogram that meets the predetermined search criteria.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic depiction of a test and measurement system according to the present description.

FIG. 2 is a method for automated searching of signal characteristics represented in a bitmap.

FIG. 3 is a bitmap populated with samples of time varying signals.

FIG. 4 is a histogram generated for a region selected from the bitmap of FIG. 3.

FIG. 5 is the bitmap of FIG. 3 shown with markers positioned at the highest Y-value associated with each local Z-value peak identified in the histogram of FIG. 4.

FIG. 6 is the bitmap of FIG. 3 shown with markers positioned at the highest Z-value associated with each local Z-value peak identified in the histogram of FIG. 4.

### DETAILED DESCRIPTION

The present description relates to automated searching of signal characteristics in a bitmap populated via sampling of a time-varying signal. More particularly, many examples in the present description relate to identifying local peaks of a plurality of different signals occurring at the same frequency or frequency ranges in a frequency-domain bitmap.

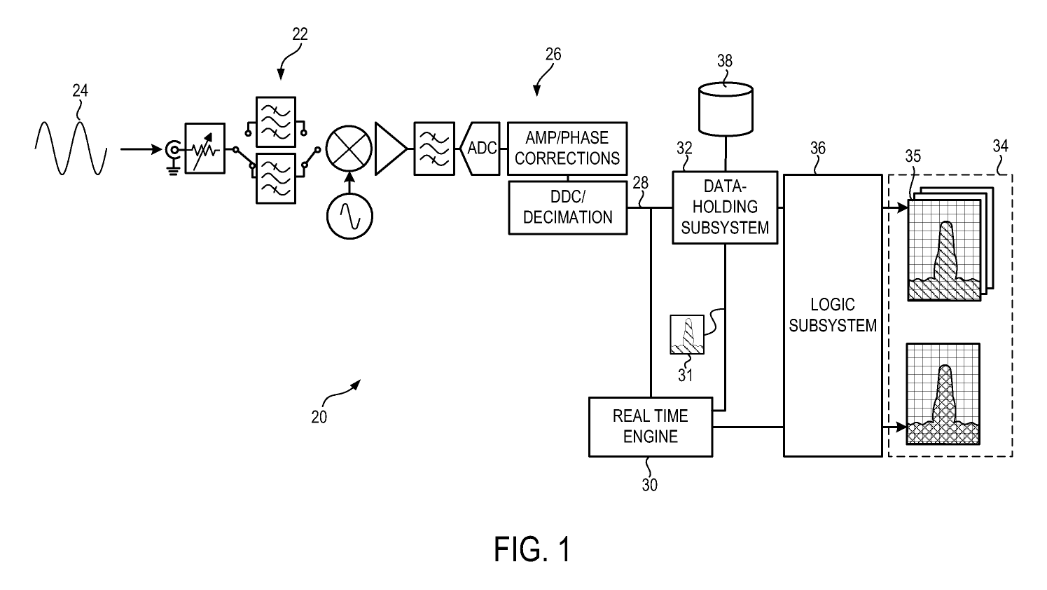

FIG. 1 depicts a signal measuring and testing system 20 according to the present description. System 20 includes a front end 22 for receiving a time-varying signal 24 and for optionally performing various processing or conditioning operations on the incoming signal. Optional processing may include filtering, mixing, down-conversion, etc. As indicated, additional components 26 may be employed to convert the incoming signal into digital form, and to perform decimation operations and/or make phase and amplitude corrections. Processing performed by components 26 may include sampling the time-varying signal 24 and sending the samples to node 28 where real-time engine 30 may generate waveforms 31 from the samples, and/or the samples may be stored as files in data-holding subsystem 32 for offline analysis. In other words, bitmaps may be created from live or stored signals using software running on logic subsystem 36 or another computing device. Also, signal characteristic analysis may be performed by software on a device by recalling a stored bitmap file. In some embodiments, system 20 may be a radio frequency (RF) signal test and measurement device. The depicted configuration is exemplary, and those skilled in the art will appreciate that a variety of other arrangements may be employed.

At node 28 in the signal path, the signal(s) exists as a digitally processed version of time-varying signal 24. This, in turn, is applied to real-time engine processing block 30. Among other things, block 30 is configured to repeatedly generate digital waveforms 31, such as frequency-domain spectrums based on samples of the time-varying signal 24. Spectrum generation may be performed using any number of digital frequency transform techniques, including chirp-z, FFT and variable-length FFT.

System 20 also includes a logic subsystem 36, a display subsystem 34, and a data-holding subsystem 32, which is operatively coupled (e.g., via a bus) with the front-end blocks and the real time block 30.

Logic subsystem 36 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Display subsystem 34 may be used to present a visual representation of data held by data-holding subsystem 32, namely, a bitmap that is populated via sampling of time-varying signal 24. As the herein described methods and processes change the data held by the data-holding subsystem, and thus transform the state of the data-holding subsystem, the state of display subsystem 34 may likewise be transformed to visually represent changes in the underlying data. Display subsystem 34 may include one or more display devices utilizing virtually any type of technology. Such display devices may be combined with logic subsystem 36 and/or data-holding subsystem 32 in a shared enclosure, or such display devices may be peripheral display devices.

Data-holding subsystem 32 may include one or more physical devices configured to hold data and/or instructions executable by the logic subsystem to implement the herein described methods and processes. When such methods and processes are implemented, the state of data-holding subsystem 32 may be transformed (e.g., to hold different data). Data-holding subsystem 32 may include removable media and/or built-in devices. Data-holding subsystem 32 may include optical memory devices, semiconductor memory devices, and/or magnetic memory devices, among others. Data-holding subsystem 32 may include devices with one or more of the following characteristics: volatile, nonvolatile, dynamic, static, read/write, random access, sequential access, location addressable, file addressable, and content addressable. In some embodiments, logic subsystem 36 and data-holding subsystem 32 may be integrated into one or more common devices, such as an application specific integrated circuit or a system on a chip.

In some embodiments, instructions held by the data-holding subsystem may take the form of computer-readable removable media, which may be used to store and/or transfer data and/or instructions executable to implement the herein described methods and processes.

Generally, data-holding subsystem 32 is configured to provide memory space for supporting real-time and other functionality of system 20. For example, a portion of time-varying signal 24 typically is sampled and retained in memory while frequency-domain transformation and other real-time operations are performed at block 30. In particular, data-holding subsystem 32 may provide a data store containing a bitmap 35 constructed from waveforms (data point arrays, traces, etc.) 31 generated from samples of time-varying signal 24. The waveforms of the time-varying signal may be stored and continually updated in bitmap 35. The bitmap 35 may include three or more dimensions (i.e., axes) that reflect any suitable signal characteristics. Examples of signal characteristics used to construct the bitmap may include time, frequency, amplitude, power (which may be derived from amplitude), phase, hit count, density (which may be derived from hit count), time since last hit, etc. As one particular example, the bitmap is a frequency, amplitude, density (X, Y, Z axes) bitmap constructed from frequency-domain spectrums captured via sampling of the time-varying signal.

In some cases, bitmap 35 may be displayed by display subsystem 34 while being updated in real-time. System 20 may also include physically or logically separate storage location 38, which may be employed for storage of signals that may be subjected to detailed offline analysis. In such cases, bitmap 35 may be constructed from samples captured for a selected period of time and stored for analysis in data holding subsystem 32. As such, the bitmap may be uploaded from data-holding subsystem 32 and displayed by display subsystem 34 such that it shows samples for the selected period of time.

One reason in some settings for the data retention is to enable a portion of the time-varying signal to be captured and analyzed more extensively offline, for example using processing operations that are more intensive and resource-consumptive than could be performed during real time processing. By combining real-time processing with offline processing, measurement and test operations can be made more efficient, and scarce computing resources may be used only when needed.

It will be appreciated that in some embodiments, system 20 may take the form of a stand-alone test and measurement device. In some embodiments, the front end hardware used to capture and process the time-varying signal may take the form of a measurement device in communication with the data-holding subsystem which may store the samples and construct the bitmap. Further, the signal/bitmap analysis instructions may be contained in an application executed by a logic system of a computing device separate from the measurement device that may or may not include the data-holding subsystem.

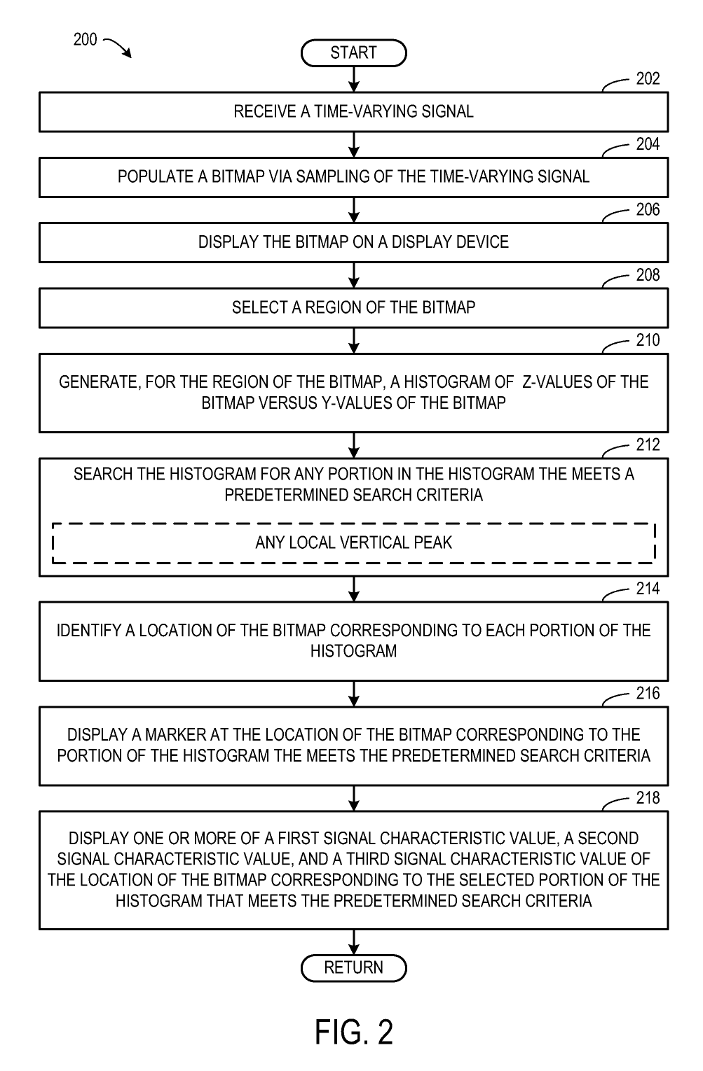

As discussed above, analysis may be performed on a bitmap populated with samples of a time-varying signal to extract information associated with signal characteristics of the time-varying signal. In some cases, this analysis may be automated. That is, the analysis may be performed by software/firmware with little or no manual input by a user. FIG. 2 is a flow diagram of an embodiment of a method 200 for automated searching of signal characteristics represented in a bitmap. In some embodiments, the method may be performed “live” as the time-varying signal is sampled and processed. In some embodiments, the method may be performed on files of previously sampled data or bitmap files.

Although method 200 is broadly applicable to searching for many different types of signal characteristics, the method will be described using the specific signal situation where a plurality of signals occur in the same frequency region of a frequency-domain bitmap.

At 202, the method may include receiving a time-varying signal. As discussed above, system 20 may include a front end 22 that may be configured to receive the time-varying signal. In some embodiments, system 20 may take the form of an RF signal test and measurement device that is configured to receive the time-varying signal.

At 204, the method may include populating a bitmap via sampling of the time-varying signal. In the example of FIG. 1, system 20 may include a data-holding subsystem 32 that may include such a bitmap, and components 26 and/or 30 may be configured to sample the time-varying signal as well as perform other processing (such as generating transforms) to populate the bitmap.

Although broadly applicable to various types of signal characteristics, the bitmap will be discussed below in terms of frequency-domain information. In particular, in many of the examples herein, frequency-domain data is stored in a bitmap data structure, in which quantized power-level information is expressed as a function of frequency. Typically, information from a plurality of digital frequency-domain spectrums processed from samples of the time-varying signal and transformed into waveforms 31 will be accumulated into the bitmap data structure. Indeed, in many example embodiments, the bitmap data structure is updated and incremented through repeated successive application of the digital frequency-domain spectrums as they are generated by block 30.

The bitmap typically is generated using a high transform rate, which is desirable in many settings to facilitate detection of infrequent events. Though desirable for event detection, the high rate will often be too fast for the display device or devices used in connection with subsystem 34 to display the bitmap data, and will normally be well beyond what human eyes can perceive. Accordingly, the incoming transforms may be written into the database at full speed and then transferred to the display device at a viewable rate. For example, the display may be driven by sampling the database 10, 20, 30 or 60 times a second. These are but examples—other frame/sampling rates may be employed.

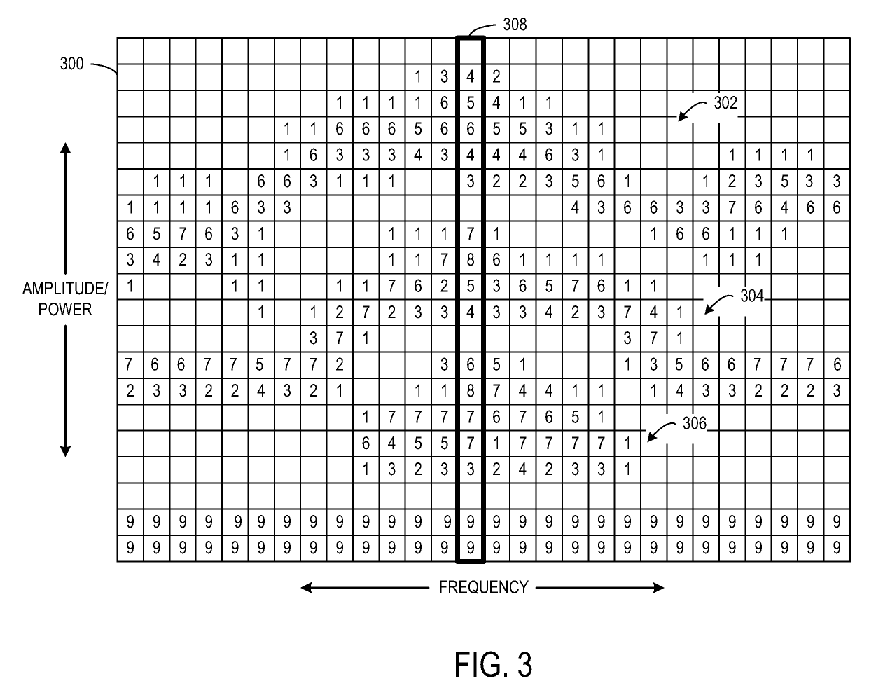

Continuing with method 200, at 206, the method may include displaying the bitmap on a display device. Display subsystem 34 may include one or more display devices configured to display the bitmap. FIG. 3 shows an example embodiment of a bitmap 300 as displayed by a display device. The bitmap 300 may be a three dimensional bitmap having an X-axis that reflects a first signal characteristic, a Y-axis that reflects a second signal characteristic, and a Z-axis that reflects a third signal characteristic. The first signal characteristic may be selected from the group consisting of frequency and time (or another suitable signal characteristic). The second signal characteristic may be selected from the group consisting of amplitude (or power) and phase (or another suitable signal characteristic). The third signal characteristic may be selected from the group consisting of density (or hit count) and time since last hit. In particular, the Z-axis may be represented in each cell of the grid by a count of how many times it was hit by an incoming spectrum during a given time period. By tracking these counts, the system can implement proportionality to allow the user to visually distinguish rare transients from normal signals and background noise.

The reader will appreciate that the bitmap figures herein provide simplified demonstrative examples, and that the actual embodiment of the database(s) stored in memory subsystem 32 will likely contain hundreds of columns and rows. In the illustrated embodiment of bitmap 300, the first signal characteristic is frequency, the second signal characteristic is amplitude, and the third signal characteristic is density. In the illustrated embodiment, the structure of bitmap 300 may be thought of as a grid created by dividing a spectrum graph into rows representing trace amplitude/power values and columns for points or ranges on the frequency axis. In some embodiments, each cell may correspond to a pixel of a display screen of the display device. In other embodiments, each cell may correspond to a plurality of pixels of a display screen of the display device. In still other embodiments, a plurality of cells may correspond to a single displayed pixel.

Over time, when different samples are taken of the time-varying signal, the individual frequency spectrums will vary and yield different values of frequency and power. The bitmap representation 300 shows a bitmap that has been updated (incremented) by applying and storing multiple different digital frequency-domain transformations in the bitmap. The nature of the spectrums applied to the bitmap is that, for each spectrum, some amplitude/power value is indicated for each value along the frequency axis, even if it is a noise floor or other baseline value, or even a value set aside to represent an “invalid point”. Further, in the bitmap representation, blank cells contain the value zero, meaning that no points from a spectrum have fallen into them yet.

In some cases, it will be desirable to map occurrence values to a color scale, in order to provide an enhanced visual representation of the data. For example, the following color mapping could be used:

| Number of | |
|---|---|
| Occurrences | Color |
| 0 | Black |
| 1 | Blue |
| 2 | Light blue |
| 3 | Cyan |
| 4 | Green blue |
| 5 | Green |
| 6 | Yellow |
| 7 | Orange |
| 8 | Red orange |
| 9 | Red |

In this example, warmer colors such as red, orange etc. are used to indicate higher numbers of occurrences. This is but an example—a variety of other intensity-grading schemes can be used.

Bitmap hit counts typically are accumulated over time. Because the rate at which spectrums arrive is faster than the display system typically can handle, a “frame” of spectrums (e.g., thousands of spectrums) is accumulated into the bitmap before the next operations are performed on the bitmap. For example, in one embodiment, 48,000 spectrums are applied to the bitmap database each second. Using a frame rate of approximately 33 times per second, the result is that approximately 1400 spectrums are applied to the bitmap database during each display frame. In another embodiment, 292,000 transforms per second are generated, and a 20 Hz frame rate is employed, such that approximately 15,000 spectrums are applied to the bitmap per display frame.

In any case, after a frame has been completed and its count data sent along to the next process, its count values can either be discarded or not. Maintaining the count values from one frame to the next may be referred to as persistence. When persistence is employed, existing counts in the bitmap database are maintained and the power/frequency values of the newly-arriving spectrums are added to increment the counts, rather than simply restarting the counts and replacing them with the values from the most recent frame.

Different types or degrees of persistence may be employed in connection with the storage and display of bitmapped frequency-domain data. For example, “infinite persistence” refers to maintaining the full accumulated count from each frame to the next, with each succeeding frame adding to the existing counts. On the other hand, “variable persistence” refers to maintaining less than the full count, which can be implemented in various ways, such as by reducing the count by a fixed fraction for each successive display frame.

Continuing with FIG. 3, bitmap 300 includes three cell/pixel groupings in which signal samples have accumulated over a time period long enough to collect a plurality of different signals. Each cell includes a value representative of density (or hit count) of samples that have occurred at the frequency and amplitude associated with that cell. The three groupings of samples correspond to three different signals provided from the time-varying signal during the sampling period, namely, a first signal 302, a second signal 304, and a third signal 306. The first signal 302 occurs at a highest amplitude range of the three signals, second signal 304 occurs at an amplitude range below that of the first signal 302, and third signal 306 occurs at an amplitude range below that of first sample 302 and second sample 304. The bitmap 300 further includes a cell/pixel grouping located along the bottom of the bitmap that is representative of a noise floor.

It will be appreciated that the above described signals are exemplary and that any suitable number of signals may be represented in a bitmap. Further, a signal may take any suitable shape. Further still, for a given frequency one signal may occur at a higher amplitude than that of another signal and at a different frequency the signal may occur at an amplitude that is lower than that of the other signal. In other words, different signals may have different peaks at different frequencies.

Returning to method 200, at 208, the method may include selecting a region of the bitmap for signal characteristic searching. In FIG. 3, the selected region 308 may be a vertical column that includes a plurality of rows and one or more columns. The number of columns employed for the region may depend on the noise level of the signal. For example, for a noisy signal a region may be selected that has a plurality of columns in order to reduce the noise of the signal and to increase searching accuracy. Further, the number of rows in a selected region may vary. For example, a selected region may include all rows of a bitmap. As another example, a selected region may include less than all rows of the bitmap, such as the smallest number of consecutive rows that includes the multiple signals of interest. In the illustrated embodiment, region 308 has only one column. As yet another example, the selected region may be the entire bitmap.

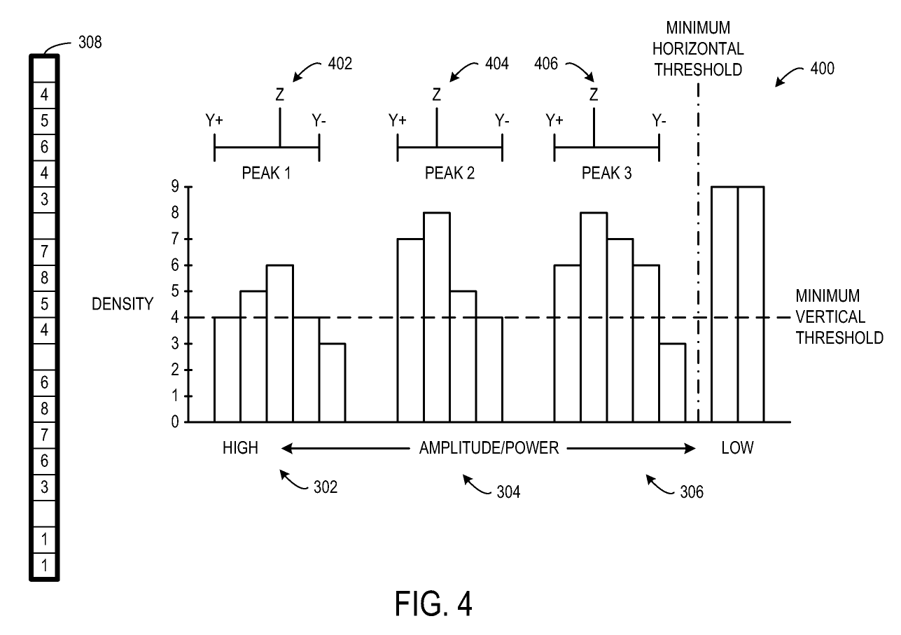

At 210, the method may include generating a histogram of Z-values of the bitmap versus Y-values of the bitmap. In some embodiments, the Z-values may be summed for each row of the selected region. In some embodiments, the Z-value may be the average value of the rows or peak value of the rows. FIG. 4 shows a histogram 400 generated from region 308 selected from bitmap 300 shown in FIG. 3. The histogram 400 is transposed such that the vertical Y-axis of histogram 400 corresponds to the Z-axis of bitmap 300 (e.g., density). The Z-values of the histogram increase up the vertical axis of the histogram. Further, the horizontal X-axis of histogram 400 corresponds to the Y-axis of bitmap 300 (e.g., amplitude). The amplitude increases leftward along the horizontal X-axis of histogram 400 and the amplitude decreases rightward along the horizontal X-axis of histogram 400. By generating such a histogram from the bitmap, a plot having three dimensions (e.g., the bitmap) may be deconstructed to a plot having two dimensions (e.g., the histogram). As such, in the histogram, for each X-value (amplitude/power) there is only one Y-value (density) as opposed to the bitmap which may have multiple Y-values (signals of varying amplitudes) for each X-value (frequency or frequency range). Accordingly, the accuracy of signal characteristic searching may be improved by condensing multiple possible values to a single value that is representative of a signal characteristic of an actual signal.

In the illustrated embodiment, since the selected region 308 includes one column of rows (e.g., one frequency), the Z-value (e.g., density) of each row is plotted against the Y-value (e.g., amplitude) of the one column. In other words, the summed Z-value for each row of the selected bitmap region is the Z-value of that row. If the selected region were to include a plurality of columns, the Z-values of each cell in the row may be summed to generate the summed Z-value (of the bitmap) used to plot the Y-value of the histogram. The histogram 400 shows the three signals (first signal 302, second signal 304, third signal 306). The noise floor is shown below a minimum amplitude threshold of the histogram and is therefore not included in the search for signal characteristics.

At 212, the method may include searching the histogram for any portion in the histogram that meets predetermined search criteria. In the illustrated embodiment, the predetermined search criteria includes finding all local vertical (Z-value) peaks in the histogram. A local peak may be defined as any portion of the histogram, above a predetermined minimum vertical (e.g., Z-value, density) threshold and above a predetermined minimum horizontal (e.g., amplitude) threshold (e.g., above an amplitude noise floor), that passes an excursion test. Each local peak may correspond to a different signal represented in the bitmap in the frequency range corresponding to the selected region.

An excursion test may include a relative delta value by which the histogram plot must decrease. Further, the histogram plot must increase from that value to determine the next local peak. Excursion tests may be performed for vertical axis (e.g., density) of the histogram as well as the horizontal axis (e.g., amplitude) of the histogram. Each excursion test may have a different relative delta value and unit since each test is performed for a different signal characteristic (e.g., density and amplitude).

In some embodiments, the searching the histogram for any portion in the histogram that meets predetermined search criteria may include filtering or smoothing the histogram. In some cases, a user may set a size in pixels to specify how strongly to filter or smooth the histogram data. The filtering may be performed alone or in combination with selecting a particular region size in order to avoid finding too many peaks located close together. This may occur in the signal situation where there exist steep, deep variations in density within a small range of amplitudes. Further, the filter may reduce the effect of jitter in the bitmap's X-domain. For example, in a spectrum bitmap, a signal might be bouncing slightly above and below some average frequency value, but the stable signal may be desired for analysis.

The excursion test may be used to identify portions of the histogram plot that correspond to a unique signal occurrence or multiple occurrences of the same signal. The test looks for points on the histogram trace that exceed the minimum vertical and minimum horizontal thresholds. The excursion test may insure that what is probably a single signal type is not mistaken as two or more different signal types due to a dip in histogram values within a portion.

In some embodiments, once particular portions of the histogram are identified as being or containing local vertical peaks, their minimum, maximum, and mean values in the filtered histogram plot's X-axis, which corresponds to the amplitude (represented by the Y-axis in the selected region of the bitmap) may be computed. A lower level may be selected for each local peak. This lower level may be the peak Z-value of the peak-containing portion of the histogram minus some difference value. This difference value could be the excursion value, or some other suitable value. Where the histogram trace first crosses the lower level to the right and the left of the actual peak are the minimum and maximum X-axis values (amplitude levels) in the filtered histogram plot for the peak-containing portion. The mean amplitude value for each peak-containing portion is the average of the amplitude values of signals included in that peak-containing portion. The minimum, maximum, and mean amplitude values may be used for marker placement to identify local peaks in the bitmap as well as peak searching which will be discussed in more detail below.

It will be appreciated that the predetermined minimum vertical threshold, the minimum horizontal threshold, and the relative delta value used for each excursion test may be set to any suitable value to identify signal characteristics of interest as defined by the predetermined search criteria. Moreover, finding any local peak is but one example of the predetermined search criteria, and it will be appreciated that other predetermined search criteria may be applied. For example, the predetermined search criteria may include finding the maximum or minimum peak of the histogram plot.

Continuing with FIG. 2, at 214 the method may include identifying a location of the bitmap corresponding to each portion of the histogram as defined by the predetermined search criteria. In the illustrated embodiment, a first local vertical peak 402 associated with first signal 302, a second local vertical peak 404 associated with second signal 304, and a third local vertical peak 406 associated with third signal 306 are identified. Further, note in the illustrated embodiment, each local vertical (Z-value) peak is defined as a portion of the histogram plot above the minimum vertical threshold and the minimum horizontal threshold, that passes an excursion test. In some cases, a local vertical (Z-value) peak may be defined as a single point as opposed to being defined as a wider portion or range of the histogram.

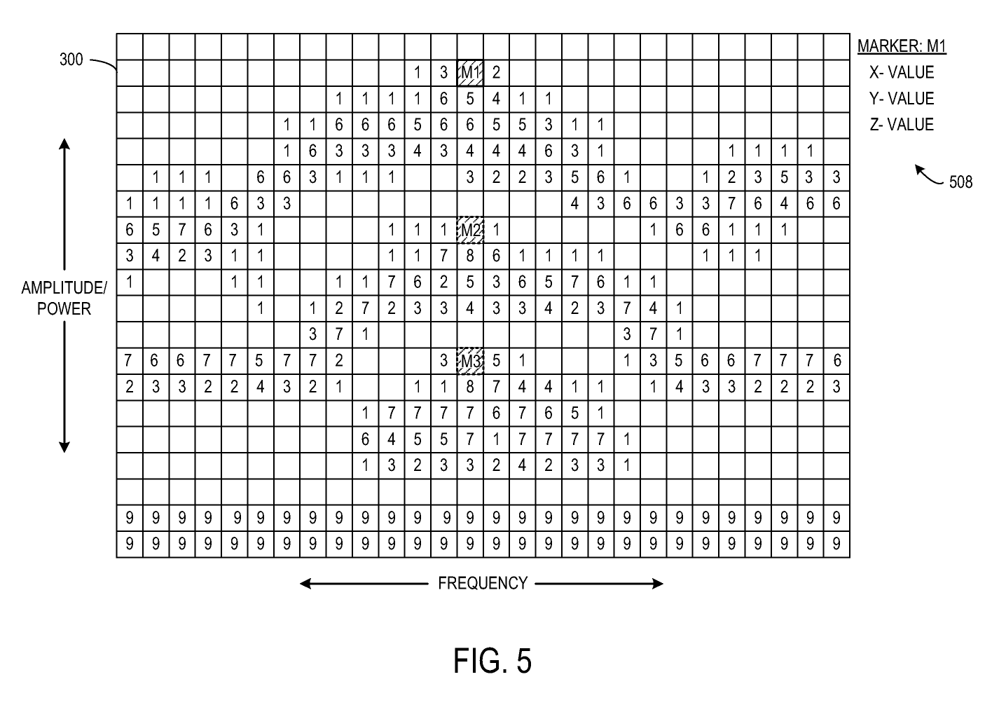

At 216, the method may include displaying a marker at the location of the bitmap corresponding to the portion of the histogram that meets the predetermined search criteria. FIG. 5 shows an example of bitmap 300 annotated with markers (M1, M2, M3) at each location of bitmap 300 corresponding to each local vertical (Z-value) peak in the histogram that is positioned at a highest Z-value associated with that local vertical peak. In other words, each local peak may include a point (indicated by Z in the histogram at peaks 402, 404, and 406) where the Z-value is highest, and the marker may be placed at the amplitude and frequency of the bitmap that corresponds to that peak Z-value. The marker for each signal may be placed at a highest Z-value for that signal to show the amplitude and frequency that that signal is most likely to occur at during the sampling period.

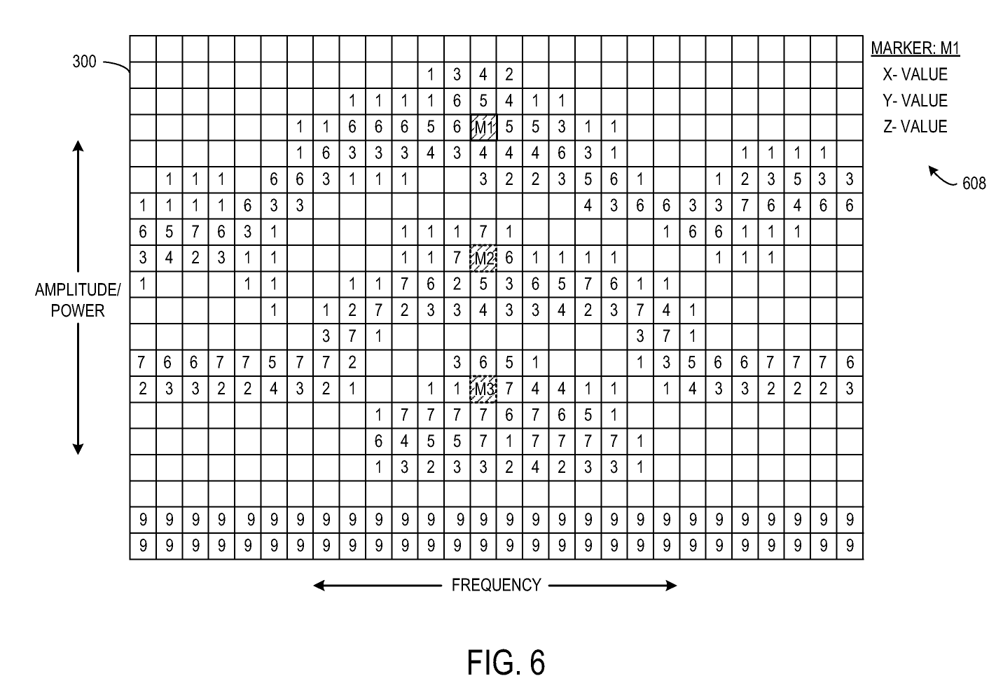

FIG. 6 shows another example of bitmap 300 annotated with markers (M1, M2, M3) at each location of bitmap 300 corresponding to each local vertical (Z-value) peak in the histogram that is positioned at a highest Y-value associated with that local vertical peak. In other words, each local peak may include a point (indicated by Y+ in the histogram at peaks 402, 404, and 406) where the Y-value is highest, that is the leftmost point of the local peak in the histogram, and the marker may be placed at the amplitude and frequency of the bitmap that corresponds to that Y-value. The marker for each signal may be placed at a highest Y-value for that signal to show the peak amplitude for that signal during the sampling period. The peak amplitude of a signal may be marked because it may be logically associated with the peak of that signal at the selected frequency region based on visual recognition of a user.

As another example, markers may be displayed at each location of the bitmap corresponding to each local vertical (Z-value) peak in the histogram that is positioned at the lowest Y-value associated with that local peak. In other words, each local peak may include a point (indicated by Y− in the histogram at peaks 402, 404, and 406) where the Y-value is lowest, that is a rightmost point of the local peak in the histogram, and the marker may be placed at the amplitude and frequency of the bitmap that corresponds to the Y-value.

In some embodiments, a marker may be displayed at the location of the bitmap corresponding to a selected portion of the histogram that meets the predetermined search criteria. In other words, a specific signal peak only may be selected to be marked for a selected frequency region. Accordingly, one signal peak may be marked at a time to identify the location in the bitmap of that signal peak. This type of marking function may be used to search between peaks of different signals. For example, in bitmap 300, the peak of first signal 302 for a selected frequency region may be marked with a marker M1 and a “Next Peak Down” search function may be invoked to move the marker to M2 at a peak of second signal 304 at the selected frequency region. Invoking the “Next Peak Down” search function again may move the marker to M3 at a peak of third signal 306 at the selected frequency region. Such a feature may be useful to mark only one selected signal peak at one time in order to simplify visual analysis of a bitmap. Similarly, other search functions may be applied to bitmap 300 to select specific signal peaks to be marked. For example, a “Next Peak Left” or a “Next Peak Right” search function may be used to find the next peak left or right of a particular signal.

In some embodiments, a marker may be displayed at the location of the bitmap corresponding to each portion of the histogram that meets the predetermined search criteria. In other words, all signal peaks may be selected to be marked for a selected frequency region. This type of marking function may be used to compare peaks of different signals. Such a feature may be useful to adjust a signal to match the amplitude, frequency, and/or duty cycle of another signal, for example.

It will be appreciated that a marker used to identify the location of the bitmap corresponding to a selected portion of the histogram that meets the predetermined search criteria may include virtually any suitable visual reference. For example, a marker may include a line cursor, a highlighting circle or other shape, an arrow, a change in pixel color, a flashing highlight, etc.

At 218, the method may include displaying one or more of a first signal characteristic value, a second signal characteristic value, and a third characteristic value of the location of the bitmap corresponding to the selected portion of the histogram that meets the predetermined search criteria. FIGS. 5 and 6 show the first signal characteristic value, the second signal characteristic value, and the third characteristic value being displayed for marker M1 at 508 and 608, respectively. In FIG. 5, the first signal characteristic value, the second signal characteristic value, and the third characteristic correspond to the frequency, amplitude, and density of the location of the bitmap corresponding to the highest Y-value of the local peak of the first signal. In FIG. 6, the first signal characteristic value, the second signal characteristic value, and the third characteristic correspond to the frequency, amplitude, and density of the location of the bitmap corresponding to the highest Z-value of the local peak of the first signal. The first signal characteristic value, the second signal characteristic value, and/or the third characteristic may be displayed so that a user may know the position of the signal peak and may make adjustments to the signal as necessary.

By generating a histogram of Z-values versus Y-values to search for signal characteristics, three dimensional X, Y, Z information may be deconstructed so that there exists only one Y-value for each X-value. This may enable a unique signal occurrence or multiple occurrences of the same type of signal to be identified for a specified frequency. Accordingly, signal characteristics may be identified in an automated manner even when a plurality of signals exists at the same frequency.

The method is quantitatively useful for matching the trigger system to the marker system of the test and measurement device. In other words, the method can be performed to automatically or conveniently set trigger values based on locations identified as points of interest by the method. Moreover, the method may be performed on a bitmap that implements persistence to identify intermittent or transient signals.

In some embodiments, the above-described methods and processes may be tied to a computing system. As an example, FIG. 1 schematically shows a computing system 20 that may perform one or more of the above described methods and processes. Computing system 20 includes a logic subsystem 36 and a data-holding subsystem 32. In some embodiments, the method may be performed by a test device as the time-varying signal is sampled. In some embodiments, the method may be performed by another computing device offline on saved files including sampled signal data and/or bitmap files stored in the data-holding subsystem.

It will be appreciated that the principles of the present discussion can be extended to accommodate analog frequency-domain spectrums. In such a case, the analog spectrums could be sampled and processed so as to produce repeated update of a bitmap data structure. Though the particulars of such a scheme might vary, the general effect would be to provide digitized versions of the analog spectrums. Thus, for purposes of the present discussion, the analog spectrums would yield a plurality of digital frequency-domain spectrums (through conversion) that would be repeatedly applied to update the bitmap database.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for automated searching of signal characteristics represented in a bitmap which is populated via sampling of a time-varying signal, where a first signal characteristic is reflected by an X-axis of the bitmap, a second signal characteristic is reflected by a Y-axis of the bitmap, and a third signal characteristic is reflected by a Z-axis of the bitmap, the method comprising:
selecting a region of the bitmap, the region having a plurality of rows and one or more columns;
generating a histogram of Z-values of the bitmap versus Y-values of the bitmap;
searching the histogram for any portion in the histogram that meets a predetermined search criteria; and
identifying a location of the bitmap corresponding to each portion of the histogram that meets the predetermined search criteria.

2. The method of claim 1, further comprising:
displaying the bitmap on a display device.

3. The method of claim 2, further comprising:
displaying a marker at the location of the bitmap corresponding to a selected portion of the histogram that meets the predetermined search criteria.

4. The method of claim 2, further comprising:
displaying a marker at the location of the bitmap corresponding to each portion of the histogram that meets the predetermined search criteria.

5. The method of claim 2, further comprising:
displaying one or more of a first signal characteristic value, a second signal characteristic value, and third characteristic value of the location of the bitmap corresponding to the selected portion of the histogram that meets the predetermined search criteria.

6. The method of claim 1, wherein the predetermined search criteria includes local vertical peaks of the histogram, above a minimum vertical threshold and a minimum horizontal threshold, which pass an excursion test.

7. The method of claim 6, wherein the location of the bitmap corresponding to each of the local vertical peaks in the histogram is positioned at a highest Z-value associated with that local vertical peak.

8. The method of claim 6, wherein the location of the bitmap corresponding to each of the local vertical peaks in the histogram is positioned at a highest Y-value associated with that local vertical peak.

9. The method of claim 1, wherein the first signal characteristic is selected from the group consisting of time and frequency.

10. The method of claim 1, wherein the second signal characteristic is selected from the group consisting of amplitude and phase.

11. The method of claim 1, wherein the third signal characteristic is selected from the group consisting of signal density and time since last hit.

12. The method of claim 1, wherein the first signal characteristic is frequency, the second signal characteristic is amplitude, and the third signal characteristic is density.

13. An RF test and measurement device, comprising:
a front end section for receiving a time-varying signal; and
a data-holding subsystem containing a bitmap generated via sampling of the time-varying signal, the bitmap having an X-axis reflecting a first signal characteristic, a Y-axis reflecting a second signal characteristic, and a Z-axis reflecting a third signal characteristic, the data-holding subsystem further containing executable instructions configured to:
generate, for a selected region of the bitmap, a histogram of Z-values of the bitmap versus Y-values of the bitmap;
search the histogram for any portion of the histogram that meets a predetermined search criteria; and
identify a location of the bitmap corresponding to each portion of the histogram that meets the predetermined search criteria.

14. The device of claim 13, further comprising:
a display device to display the bitmap; and
where the executable instructions in the data-holding subsystem are further configured to:
display, on the display device, a marker at the location of the bitmap corresponding to a selected portion of the histogram that meets the predetermined search criteria; and
display, on the display device, one or more of a first signal characteristic value, a second signal characteristic value, and a third characteristic value of the location of the bitmap corresponding to the selected portion of the histogram that meets the predetermined search criteria.

15. The device of claim 13, wherein the predetermined search criteria includes local vertical peaks of the histogram, above a minimum vertical threshold and a minimum horizontal threshold, which pass an excursion test.

16. The device of claim 13, wherein the first signal characteristic is selected from the group consisting of time and frequency.

17. The device of claim 13, wherein the second signal characteristic is selected from the group consisting of amplitude and phase.

18. The device of claim 13, wherein the third signal characteristic is selected from the group consisting of signal density and time since last hit.

19. A method for automated searching of signal characteristics comprising, at an RF test and measurement device:
receiving a time-varying signal;
populating, via sampling of the time-varying signal, a bitmap displayed by the RF test and measurement device, the bitmap having an X-axis that reflects frequency, a Y-axis that reflects amplitude, and a Z-axis that reflects density;
selecting a region of the bitmap, the region having a plurality of rows and one or more columns;
generating, for the region of the bitmap, a histogram of density values of the bitmap versus amplitude values of the bitmap;
searching the histogram for any local density peak in the histogram, above a minimum density threshold and a minimum amplitude threshold, which passes an excursion test; and
displaying a marker in the bitmap at a location corresponding to one or more local density peaks found in the histogram.

20. The method of claim 19, further comprising:
displaying one or more of a frequency value, an amplitude value, and a density value of the location of the bitmap corresponding to the one or more local peaks found in the histogram.
